(19) United States
(12) Patent Application Publication
(10) Pub. No.: US 2023/0184391 A1
(43) Pub. Date: Jun. 15, 2023

(54) GAS EXPORT ASSEMBLY

(71) Applicant: Siemens Gamesa Renewable Energy A/S, Brande (DK)

(72) Inventor: Gustav Hoegh, Vejle (DK)

(21) Appl. No.: 18/061,627

(22) Filed: Dec. 5, 2022

(30) Foreign Application Priority Data
Dec. 10, 2021 (EP) 21213789.7

(51) Int. Cl. F17D 5/00; F17D 1/02; F17D 3/14

(52) U.S. Cl. CPC F17D 5/005; F17D 1/02; F17D 3/145

(57) ABSTRACT

A gas export assembly is provided including a gas production facility adapted to generate pressurized gas for export to a remote facility through a pipeline; a determining an upper humidity threshold for the export gas in the pipeline; a determining, on the basis of the upper humidity threshold, a pipeline inlet humidity for the export gas, which pipeline inlet humidity is lower than the upper humidity threshold; and a regulator stage adapted to adjust the humidity of the export gas to the pipeline inlet humidity.

### CROSS-REFERENCE TO RELATED APPLICATIONS

This application claims priority to EP Application No. 21213789.7, having a filing date of Dec. 10, 2021, the entire contents of which are hereby incorporated by reference.

### FIELD OF TECHNOLOGY

The following relates to a gas export assembly.

### BACKGROUND

Wind energy can be used to drive large-scale electrolysis units in order to generate “green” hydrogen gas. The hydrogen gas can then be transported via pipeline to its destination, for example an offshore wind energy plant can export hydrogen through a pipeline to an onshore facility.

Hydrogen can be produced from electrolysis of water, with oxygen and heat as by-products. An offshore wind energy plant can drive a desalination unit to convert sea-water into water suitable for a water electrolysis system. There are several ways of performing water electrolysis, for example alkaline electrolysis using a suitable electrolyte. Alternatively, water can be split in a “proton exchange membrane” (PEM) electrolysis system that is based on a proton-permeable polymer membrane. PEM electrolysis has several advantages over the older techniques, for example it can achieve a favorably high-power density and can be powered by an inherently fluctuating power supply such as wind energy. A high-pressure PEM electrolyzer can provide compressed hydrogen gas at a high temperature and pressure, for example a pressure in the order of 50-200 bar (5 MPa-20 MPa) and a temperature of about 70°.

A gas produced by water electrolysis can have a high-water vapor content, which must be removed before the gas is used for its ultimate purpose. Removal of the water vapor can be done at any stage between initial production and the final destination facility. Generally, some water vapor may be removed at an early stage, and the remainder can be removed prior to using the gas for its ultimate purpose. However, water vapor content may lead to problems when the gas is transported through a subsea pipeline from an offshore plant, since the water vapor can condense in the cold pipeline, ultimately reducing the available space in the pipeline and restricting the flow of hydrogen. If the pipeline follows the contour of a dip or valley in the seabed, the accumulated water condensate in such a “U-bend” reduces the flow rate and may even block the pipeline entirely. Therefore, before feeding it into the export pipeline, a gas containing water vapor should be at least partially dried in order to lower its water vapor content.

There are various possible ways of removing water vapor from gas, for example the gas can be passed through a drying tube filled with a suitable hygroscopic desiccant such as calcium chloride. However, owing to their relatively high cost, such techniques are unsuitable for large-scale drying of pressurized gas, for example hydrogen gas that is generated by a high-pressure PEM electrolyzer.

### SUMMARY

An aspect relates to providing an improved way of treating gas for export through a subsea pipeline.

This aspect is achieved by the claimed gas export assembly and by the claimed method of operating a gas export assembly.

According to embodiments of the invention, the gas export assembly comprises a gas production facility adapted to generate pressurized gas for export to a remote facility through a pipeline. The gas export assembly further comprises a determining an upper humidity threshold for the export gas in the pipeline and a determining, on the basis of the upper humidity threshold, a pipeline inlet humidity for the export gas, which pipeline inlet humidity is lower than the upper humidity threshold. The gas export assembly further comprises a regulator stage adapted to adjust the humidity of the export gas to the pipeline inlet humidity. A combination of inlet temperature and inlet pressure is selected to ensure that the upper humidity level is not exceeded during transport of the gas through the pipeline, thereby significantly reducing or even eliminating the occurrence of water condensation in the pipeline.

The gas produced by the gas production facility shall be understood to comprise an amount of water vapor. In the context of embodiments of the invention, the “upper humidity level” of the export gas in the pipeline shall be understood as the maximum relative humidity or the maximum absolute humidity of the gas and shall be understood as the level above which water vapor would condense from the gas in the pipeline. The conditions along the interior of a pipeline are seldom constant, and different sections of the pipeline may have different pressures and temperatures. Embodiments of the invention are based on the insight that (usually) the lowest temperature inside the pipeline will determine primarily whether condensation of water vapor will occur, and to what extent, since the relative or absolute humidity will be highest in the coldest pipeline region.

An advantage of the inventive gas export assembly is that the regulator stage already treats the gas—prior to feeding it into the pipeline—to reach a temperature and pressure which together ensure that the relative or absolute humidity of the gas does not exceed the threshold determined for the coldest pipeline region.

According to embodiments of the invention, the method of operating such a gas export assembly comprises the steps of determining an upper humidity threshold for the export gas in the pipeline and then determining, on the basis of the upper humidity threshold, a pipeline inlet humidity for the export gas, which pipeline inlet humidity is lower than the upper humidity threshold; and subsequently adjusting the humidity of the export gas to the pipeline inlet humidity. In a final step, the treated gas is fed into the pipeline.

An advantage of the inventive method is that with relatively little effort, the properties of the gas—prior to export—are set up in such a way as to avoid or eliminate undesirable condensation of water vapor in the pipeline. The inventive method ensures that the carrying capacity of the pipeline will not be reduced by an accumulation of liquid water, which would otherwise reduce the available volume inside the pipeline.

Particularly advantageous embodiments and features of the invention are given by the dependent claims, as revealed in the following description. Features of different claim categories may be combined as appropriate to give further embodiments not described herein.

In the following, it may be assumed that the gas export assembly is realized at an offshore facility and is powered by wind energy. For example, a wind farm can comprise multiple wind turbines to drive modules of a gas production facility. The gas can be transported to a remote facility such as an onshore treatment plant via a pipeline or network of pipelines. Specifically, an offshore facility can comprise a wind turbine mounted on a support structure, and an embodiment of the inventive gas export assembly, also supported by the support structure, and powered by the wind turbine. In the following, without restricting embodiments of the invention in any way, it may be assumed that a gas production facility is a water electrolyzer, a high-pressure PEM water electrolyzer assembly for the production of pressurized hydrogen gas.

For this reason, water vapor in the wet hydrogen gas generated by a high-pressure PEM electrolyzer will condense in the interior of a cold subsea pipeline. The temperature of the gas output by a high-pressure PEM electrolyzer can be in the order of 70° C.-100° C., for example, while the temperature along the pipeline might be very low in places, e.g., only a few degrees above 0° C.

The expression “humidity of a gas” refers to the concentration of water vapor in the gas. A “wet” or “non-dry” gas is any gas that contains some fraction of water vapor. The amount of water vapor that can be held by a gas depends on the temperature and pressure of the gas. A “cold” volume of gas can hold less water vapor that the same volume of gas at a higher temperature. The absolute humidity of the gas is the total mass of water vapor in a certain volume of the gas, and can be expressed as weight per volume, for example g/cm³. The relative humidity of a wet gas compares the absolute humidity of the gas to its maximum humidity at a certain temperature and is the ratio of the actual quantity of water vapor in the gas to the quantity of water vapor that could be held by the gas at that temperature. Relative humidity is expressed as a percentage. The specific humidity of a volume of gas is the ratio of water vapor to the total gas mass. In the following, without restricting embodiments of the invention in any way, the description refers to the relative humidity, but it shall be understood that the inventive method can equally well be performed using the absolute humidity as a basis for determining a favorable combination of inlet temperature and inlet pressure. Equally, the specific humidity may be used as a basis for determining a favorable combination of inlet temperature and inlet pressure.

To this end, the inventive gas export assembly comprises a determining the lowest temperature in the interior of the pipeline along a relevant length, for example between the inlet and outlet ends of that stretch of pipeline. The lowest temperature in the pipeline can be determined from a previously established temperature profile, for example. To this end, in an embodiment of the invention, an initial calibration step is performed to collect temperature data in the interior of the pipeline over its length. For example a device such as a “pig”, equipped with temperature sensors, can be made travel along the length of the pipeline at a suitable rate. The measured temperature readings are evaluated to establish the temperature profile for that pipeline.

Alternatively or in addition, the lowest temperature in the pipeline can be determined from ad hoc measurement data provided by suitably placed temperature sensors. This lowest temperature may occur anywhere along the pipeline, depending on the topography of the seabed, the length of the pipeline, the geographical location of the pipeline, etc. The ambient temperature may vary due to changing soil conditions, water depth etc. For this reason, different combinations of inlet temperature and inlet pressure may be identified for the pipelines of different gas export assemblies, even if the gas export assemblies are identical and the pipeline lengths are the same. The temperature along a pipeline will vary also on account of the heating effect of the infeed gas, in other words the gas entering the pipeline will lose heat to the pipeline.

The humidity of the export gas can reach a critical level owing to an unfavorable combination of temperature and pressure at some point along the pipeline. The region at which this unfavorable combination of parameters applies is not necessarily the coldest region in the pipeline, since relative humidity is determined by both temperature and pressure. Since temperature is usually the dominant factor, the following description assumes—without restricting embodiments of the invention in any way—that the critical region in the pipeline is also the coldest region.

The inlet pressure is determined on the basis of the lowest temperature in the pipeline, and also on the basis of a desired flow rate. A certain pressure differential between inlet and outlet of the pipeline will be required to ensure that the gas moves at a suitable rate through the pipeline.

From the lowest temperature in the pipeline and the corresponding pressure at that location, an upper threshold ϕ_{C} for the relative humidity of the export gas can then be chosen. For example, the upper relative humidity threshold ϕ_{C} may be set at a maximum of 90% in the critical region of the pipeline, i.e.,

ϕ_{C}{T_{C}, P_{C}}<90% (1)

From this, and with knowledge of the changes in temperature and pressure between pipeline inlet and the coldest pipeline region, a suitable level of relative humidity at the pipeline inlet can be determined such that equation (1) is satisfied over the entire pipeline.

The temperature and pressure of the gas to be fed into the pipeline can be manipulated in two ways in order to achieve this: the hot pressurized gas can be cooled, since cooling will result in condensation of water vapor; and the gas can be decompressed or expanded, since a decrease in pressure is associated with a decrease in relative humidity.

The temperature of the gas output by the PEM electrolyzer is reduced as it passes through the cooling module, which can be a water-cooled or air-cooled heat exchanger that primarily serves to extract water vapor from the hot pressurized gas by condensation. In an embodiment of the invention, the cooling module is a heat exchanger, and water vapor condenses from the gas as it passes over relatively cooler surfaces of the heat exchanger. At the output of the cooling module, the temperature of the gas has been reduced. The result of decreasing the temperature of the gas has the effect of raising its relative humidity. At the output of the cooling module, the relative humidity of the gas will be at or close to 100%.

In a subsequent stage, the pressure of the partially dried gas is lowered. To this end, the regulator stage of the inventive gas export assembly comprises a pressure reducer adapted to reduce the pressure of the gas to the pipeline inlet pressure. For example, the pressure reducer can be realized as a pressure expansion valve or any other suitable apparatus. This step of pressure reduction is carried out to reduce the relative humidity of the gas to the desired inlet humidity level, which is below the upper humidity threshold ϕ_{C} as explained above., In an embodiment, the inlet relative humidity level is at most 70%, more at most 50% of the upper humidity threshold ϕ_{C}.

The partially dried, cooled and pressure-reduced gas is then fed into the export pipeline. Because of the controlled treatment prior to the infeed step, the reduced relative humidity of the partially dry gas ensures that, even when the gas reaches the coldest part of the pipeline, the remaining water vapor will not condense but will continue to the carried by the gas to the other end of the pipeline.

### BRIEF DESCRIPTION

Some of the embodiments will be described in detail, with reference to the following figures, wherein like designations denote like members, wherein:

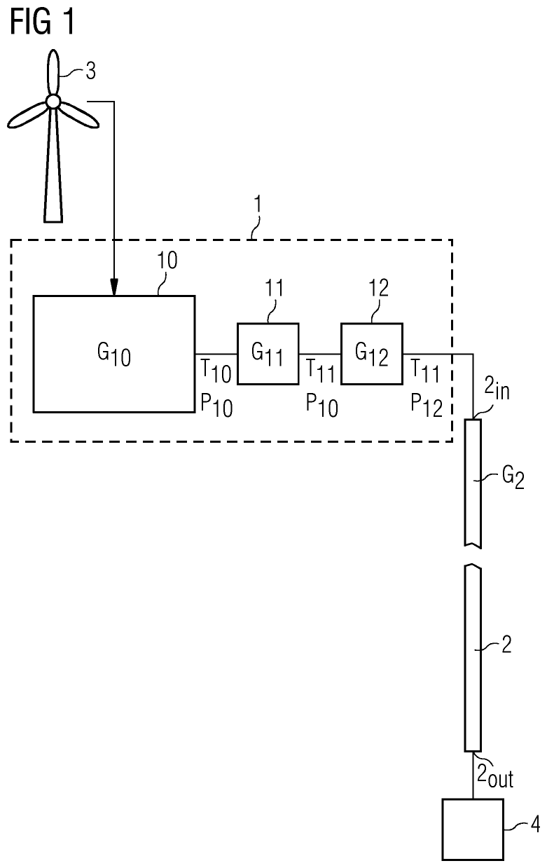

FIG. 1 shows a block diagram of an embodiment of the inventive gas export assembly;

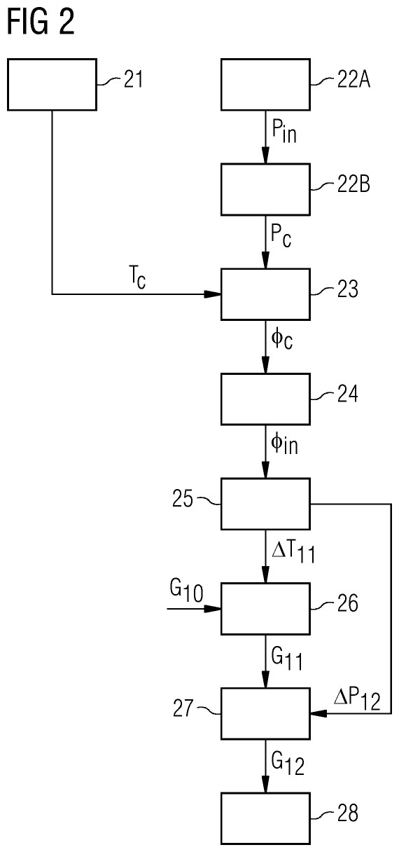

FIG. 2 is a flowchart to illustrate the inventive method;

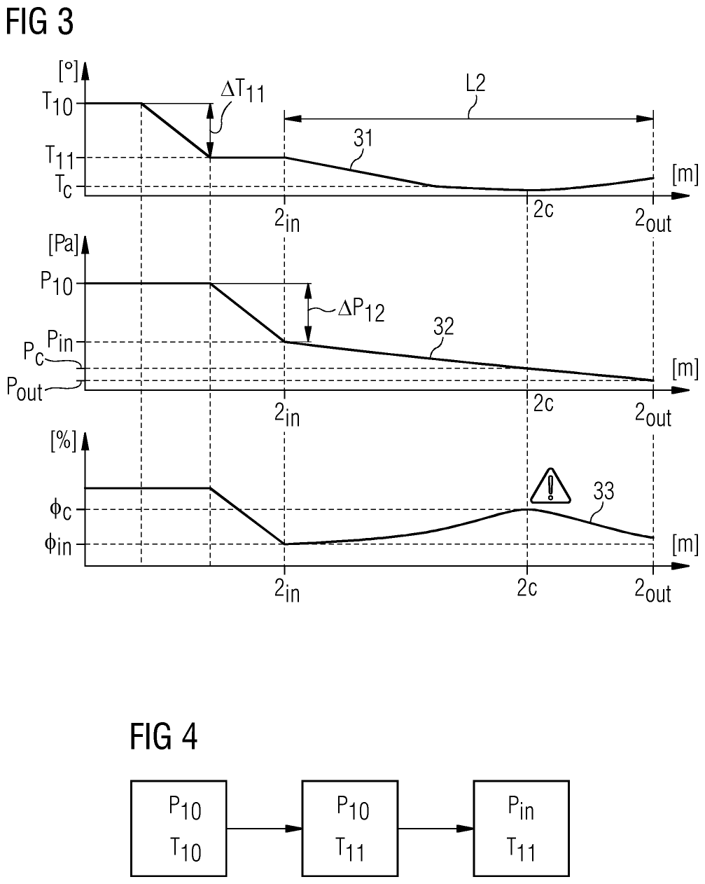

FIG. 3 shows temperature, pressure and relative humidity at different stages in the inventive method; and

FIG. 4 illustrates the concepts applied by the inventive method.

### DETAILED DESCRIPTION

FIG. 1 is a simplified block diagram of an embodiment of the inventive gas export assembly 1. The diagram shows a high-pressure PEM electrolyzer 10, a heat exchanger 11, a pressure reducer 12 and an export pipeline 2. The gas export assembly 1 is implemented at an offshore location, and is powered by a wind turbine 41. The wind turbines of an offshore wind park can power many such high-pressure PEM electrolyzers 10 to generate large quantities of “green” hydrogen G₁₀ at a favorably high purity. The coolant for the heat exchanger 11 may be cold seawater. The pipeline 2 between the wind turbine 41 and a destination facility 42 at a remote location may have a length of many kilometers.

FIG. 2 is a flowchart 20 to illustrate the inventive method. In a preparatory step 21, the lowest temperature T_{c} in the pipeline is determined or estimated. This can be done using temperature sensing means as explained above. In another preparatory step 22A, the minimum inlet pressure Pᵢₙ is determined in order to achieve a satisfactory flow rate through that pipeline. This can be done using information regarding the dimensions of the pipeline, a required or desired flow rate, and a desired outlet pressure Pₒᵤₜ. From the minimum inlet pressure Pᵢₙ, the pressure P_{c} at the coldest or “critical” pipeline region is estimated in step 22B.

From the lowest temperature T_{c} and the corresponding pressure P_{c}, an upper threshold ϕ_{C} for the relative humidity of the export gas is determined in a subsequent step 23 as explained above regarding equation (1). From this, and with knowledge of the changes in temperature and pressure between pipeline inlet and the coldest pipeline region, a suitable level of relative humidity ϕᵢₙ at the pipeline inlet 2ᵢₙ is determined in step 24 such that equation (1) is satisfied over the entire pipeline.

The temperature and pressure of the gas to be fed into the pipeline 2 can be manipulated in two ways in order to achieve this: the hot pressurized gas can be cooled, since cooling will result in condensation of water vapor; and the gas can be decompressed or expanded, since a decrease in pressure is associated with a decrease in relative humidity.

The required minimum pressure Pᵢₙ at the pipeline inlet 2ᵢₙ can be determined from a desired gas flow rate and the known pressure drop ΔP₂ across the pipeline, i.e.,

ΔP₁₂=P₁₀−Pᵢₙ (3)

where Pₒᵤₜ is the desired pressure at the pipeline output 2ₒᵤₜ. Since the pressure drop across the cooling unit 11 may be assumed to be negligible, the required pressure drop ΔP₁₂ across the pressure reducer 12 can be determined from

ΔP₁₂=P₁₀−Pᵢₙ (3)

In the inventive method, the pressurized wet gas G₁₀ originating from the gas production facility 10 is cooled in step 26. This step of cooling will result in condensation of water vapor, so that the gas G₁₁ output by the cooling unit 11 is partially dried and has been cooled to a suitable lower temperature T₁₁. The pressure drop across the cooling unit 11 may be assumed to be minimal.

Subsequently, the cooled (and partially dried) gas G₁₁ is decompressed in step 27 to reduce its pressure. The decompressor output pressure P₁₂ is essentially the pipeline inlet pressure Pᵢₙ. Within the constraints of equation (3), the decompression stage 12 achieves a large pressure drop to obtain a favorably low relative humidity ϕᵢₙ of the gas G₁₂ at the decompressor output, i.e., at the pipeline inlet 2ᵢₙ such that

ϕᵢₙ{Tᵢₙ, Pᵢₙ}«π_{C} (4)

i.e., the relative humidity at the pipeline inlet is significantly lower than the critical relative humidity ϕ_{C} by a favorably large margin, bearing in mind that the temperature of the gas G₂ (in the pipeline as shown in FIG. 1) will drop as it travels through the pipeline 2, reaching its lowest temperature at the critical region 2_{C}. However, since the relative humidity of the gas at the pipeline inlet 2ᵢₙ was deliberately reduced by the treatment stages 11, 12, the increase in relative humidity at the lower temperature T_{C} and pressure P_{C} at the pipeline critical region 2_{C} is such that the upper limit ϕ_{C} for relative humidity is not exceeded.

The temperature at the pipeline inlet 2ᵢₙ can be at any level as long as equation (1) will apply over the length of the pipeline 2. The temperature of the inlet gas G₁₂ may be raised if desired, without affecting its relative humidity, since water vapor is not removed in a heating process.

Depending on various factors such as pipeline length, electrolyzer output temperature, etc., the temperature of the inlet gas G12 may affect the pipeline temperature profile. In such conditions, the cooling unit 11 may be regulated to cool its output gas G11 to suitable temperature T₁₁.

FIG. 3 shows temperature, pressure and relative humidity at different stages in the inventive method as explained in FIG. 1 and FIG. 2. The uppermost part of the diagram shows the temperature profile 31 of hydrogen gas between its output from the gas production facility 10 through all stages of the inventive gas export assembly 1 and through the pipeline 2. To illustrate the effect of the inventive method, the X-axis represents distance. The pipeline 2 can have a length L2 of many kilometers.

In a first step 21, the lowest or “critical” temperature T_{c} along the pipeline 2 is established. From the relationship between temperature, pressure and relative humidity, it can be established that the relative humidity of the export gas will be highest at this point 2_{C} along the pipeline. Embodiments of the invention are based on the insight that, by keeping the relative humidity below a certain threshold at this point 2_{C} along the pipeline, condensation of water vapor can be avoided. A suitable upper threshold ϕ_{C} of relative humidity for that pipeline region 2_{C} is then chosen, for example 90%.

A pressure profile 32 can be established from a known desired rate of gas transfer along the pipeline, i.e., a pressure differential can be identified to achieve a desired flow rate. Knowing the pressure Pₒᵤₜ of the export gas at the pipeline outlet, and knowing the pipeline length L2, the pressure Pᵢₙ at the pipeline inlet can be determined, for example by extrapolation. This allows the pressure P_{c} at the critical region of the pipeline 2 to be determined in step 22B of the flowchart.

Using the known information about temperature and pressure profiles 31, 32 along the pipeline 2, and the established maximum relative humidity ϕ_{C} at that critical region 2_{C}, a suitable relative humidity ϕᵢₙ at the pipeline inlet 2ᵢₙ is then determined as explained above in step 24. With this lower relative humidity ϕᵢₙ as “target”, a suitable temperature drop ΔT₁₁ across the cooling unit 11 and a suitable pressure drop ΔP₁₂ across the pressure reducer 12 are determined. These parameters are chosen to result in a reduced relative humidity ϕᵢₙ at the pipeline inlet 2ᵢₙ, so that, by the time the export gas reaches the critical region 2_{C} of the pipeline, its relative humidity will not be able to increase above the identified threshold ϕ_{C}.

With these criteria, the cooling and decompression steps 26, 27 can be performed to achieve the desired relative humidity ϕᵢₙ. For example, if the wind energy plant is located in the North Sea and the coolant is seawater at a temperature in the order of 10° C.-12° C., the temperature of the hydrogen gas G₁₀ can be reduced relatively quickly from an initial temperature T₁₀ in the order of 70° C. to a lower temperature T₁₁ in the order of 10° C., thereby extracting a significant fraction of the water content from the gas G₁₀. The pressure of the gas G₁₁ at the output of the cooling unit 11 remains essentially unchanged. The pressure of the partially dried and cooled gas G₁₁ can be reduced from its initial pressure P₁₀ in the order of 6000000 Pa (60 bar) to a desired pipeline infeed pressure Pᵢₙ in the order of 3000000 Pa (30 bar). The temperature of the gas G₁₂ at the output of the decompression unit 12 remains essentially unchanged.

The combination of infeed temperature T₁₁ and infeed pressure Pᵢₙ ensure that the relative humidity of the export gas in the pipeline 2 will not rise above the upper threshold ϕ_{C} of relative humidity in the pipeline, so that even at the critical low-temperature in the pipeline 2, condensation of the residual water vapor will not occur.

FIG. 4 illustrates the concepts applied by the inventive method. Initially, as indicated on the left, the high-pressure PEM electrolyzer outputs hydrogen G₁₀ at a high temperature T₁₀ and a high pressure P₁₀. During the temperature-reduction stage 11 of the regulator, the gas undergoes isobaric cooling during which the pressure P₁₀ remains essentially the same, but the temperature is reduced from the initial temperature T₁₀ to the inlet temperature T₁₁. During the pressure-reduction stage 12 of the regulator, the gas undergoes isothermal decompression during which the temperature T₁₁ remains essentially the same, but the pressure is decreased from the initial pressure P₁₀ to the inlet pressure Pᵢₙ.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A gas export assembly comprising:
a gas production facility configured to generate pressurized gas for export to a remote facility through a pipeline;
a means of determining an upper humidity threshold for an export gas exported in the pipeline;
a means of determining, on a basis of the upper humidity threshold, a pipeline inlet humidity for the export gas, the pipeline inlet humidity being lower than the upper humidity threshold; and
a regulator stage configured to adjust a humidity of the export gas to the pipeline inlet humidity.

2. The gas export assembly according to claim 1, wherein the regulator stage comprises a cooling module configured to extract water vapor from the pressurized gas.

3. The gas export assembly according to claim 1, wherein the regulator stage comprises a pressure reducer configured to reduce a pressure of the cooled and partially dried gas.

4. The gas export assembly according to claim 1, comprising a means of determining a lowest temperature in an interior of the pipeline and a means of determining a pressure in the interior of the pipeline at a region of lowest temperature.

5. The gas export assembly according to claim 4, wherein the upper humidity threshold is determined on a basis of the lowest temperature and the pressure.

6. An offshore facility comprising:
a wind turbine; and
a gas export assembly according to claim 1 powered by the wind turbine.

7. The offshore facility according to claim 6, wherein the gas production facility comprises a high-pressure PEM water electrolyzer assembly for a production of pressurized hydrogen gas.

8. A method of operating the gas export assembly according to claim 1, the method comprising:
determining the upper humidity threshold for the export gas in the pipeline;
determining, on the basis of the upper humidity threshold, the pipeline inlet humidity for the export gas, the pipeline inlet humidity being lower than the upper humidity threshold;
adjusting the humidity of the export gas to the pipeline inlet humidity; and subsequently feeding the export gas into the pipeline.

9. The method according to claim 8, wherein the pipeline inlet pressure is determined on a basis of a desired outlet pressure.

10. The method according to claim 1, wherein the regulator arrangement comprises a pressure reducer, and wherein a pressure drop across the pressure reducer is determined on a basis of the pipeline inlet pressure.

11. The method according to claim 1, wherein a pipeline inlet temperature is deduced at least on a basis of the pipeline inlet humidity.

12. The method according to claim 1, comprising a step of determining a pressure profile over a length of the pipeline.

13. The method according to claim 1, comprising a step of determining a temperature profile in a pipeline interior over a length of the pipeline.

14. The method according to claim 1, comprising an initial calibration step in which temperature data is collected in an interior of the pipeline over a length of the pipeline.

15. The method according to claim 1, wherein the pipeline inlet humidity comprises a relative humidity of at most 85%.
